(19) United States
(12) Patent Application Publication
(10) Pub. No.: US 2008/0027192 A1
(43) Pub. Date: Jan. 31, 2008

(54) Process for Preparing Catalyst Systems Comprising Late Transition Metals

(75) Inventors: Marc-Oliver Kristen, Kelkheim (DE); Harald Schmitz, Weinheim (DE)

Correspondence Address: BASELL USA INC., INTELLECTUAL PROPERTY, 912 APPLETON ROAD, ELKTON, MD, 21921, US

(73) Assignee: Basell Polyolefine GmbH, Wesseling (DE)

(21) Appl. No.: 11/791,910

(22) PCT Filed: Dec. 2, 2005
(86) PCT No.: PCT/EP05/12835

§ 371 Date: May 30, 2007

Related U.S. Application Data
(60) Provisional application No. 60/644,085, filed on Jan. 14, 2005.

(30) Foreign Application Priority Data
Dec. 3, 2004 (DE) 10 2004 058 578.4

(51) Int. Cl. C08F 4/52

(52) U.S. Cl. 526/132; 502/104; 502/126

(57) ABSTRACT

The present invention relates to a process for preparing a catalyst system for olefin polymerization, which is obtainable by bringing at least one complex of a transition metal of groups 8 to 10 of the Periodic Table of the Elements, at least one aluminoxane and at least one boron compound into contact with one another, catalyst systems obtainable by this process, the use of the catalyst systems for the polymerization of olefins and a process for preparing polyolefins in which these catalyst systems are used.

This application is the U.S. national phase of International Application PCT/EP2005/012835, filed Dec. 2, 2005, claiming priority to German Patent Application 102004058578.4 filed Dec. 3, 2004, and the benefit under 35 U.S.C. 119(e) of U.S. Provisional Application No. 60/644,085, filed Jan. 14, 2005; the disclosures of International Application PCT/EP2005/012835, German Patent Application 102004058578.4 and U.S. Provisional Application No. 60/644,085, each as filed, are incorporated herein by reference.

### DESCRIPTION

The present invention relates to a process for preparing a catalyst system for olefin polymerization, which is obtainable by bringing at least one complex of a transition metal of groups 8 to 10 of the Periodic Table of the Elements, at least one aluminoxane and at least one boron compound into contact with one another, catalyst systems obtainable by this process, the use of the catalyst systems for the polymerization of olefins and a process for preparing polyolefins in which these catalyst systems are used.

Research and development on the use of organic transition metal compounds, in particular metallocenes, as catalyst components for the polymerization and copolymerization of olefins with the objective of preparing tailored polyolefins have been pursued intensively in universities and in industry over the past 15 years.

In addition to the metallocenes, increasing attention is now being directed at new classes of transition metal compounds containing no cyclopentadienyl ligands, in particular complexes of “late transition metals” such as Ni, Pd (WO 96/23010), Fe or Co (WO 98/27124), which contain uncharged ligands, for example diimines or bisiminopyridines, as catalyst components. While Ni or Pd complexes (WO 96/23010) catalyze the formation of highly branched polymers which have hitherto been of little commercial interest, the use of Fe or Co complexes leads to the formation of highly linear polyethylene having a very low comonomer content.

The catalyst activity of catalyst systems based on late transition metal complexes in olefin polymerization is frequently still insufficient for industrial use.

It is known from WO 98/40418 that the activity of supported metallocene catalysts which have been activated with methylaluminoxane can be increased by addition of specific boron compounds. Catalyst systems based on complexes of late transition metals are not mentioned.

EP 1172385 describes boroxine-modified, homogeneous polymerization catalysts which have been prepared from an iron-bisiminopyridine complex and methylaluminoxane. The addition of the boroxine firstly leads to a reduction in the proportion of low molecular weight material in the polymerization, and secondly the productivity of the catalyst systems is reduced.

Polym. Int. 2004, 53, 37-40, describes the preparation of an ethylisobutylaluminoxane modified with boronic acid, in which a boronic acid is firstly reacted with triethylaluminum and, after addition of triisobutylaluminum, the mixture is hydrolyzed with water at low temperatures to form a boronaluminoxane. The activation of an iron complex by means of a boron-aluminoxane prepared in this way gives a polymerization catalyst having an improved activity at elevated temperatures compared to an iron catalyst activated by means of simple methylaluminoxane. However, the method described for preparing the modified aluminoxane is too complicated and therefore unsuitable for industrial use.

It was therefore an object of the present invention to find an activation method for “late transition metal complexes” which is simple to carry out industrially and makes it possible to obtain polymerization catalysts having improved activities and is also suitable for the industrially relevant, supported catalyst systems.

We have accordingly, a process for preparing a catalyst system for olefin polymerization, which is obtainable by bringing
A) at least one complex of a transition metal of groups 8 to 10 of the Periodic Table of the elements, and
B) at least one aluminoxane
into contact with one another, wherein
C) at least one boron compound of the formula (I),
   (R¹)ₐ—B—(OR²)_{b} (I)

where
R¹ is an organic radical having from 1 to 40 carbon atoms,
R² is hydrogen or an organic radical which has from 1 to 40 carbon atoms and is bound via a carbon atom,
a is 1 or 2,
b is 1 or 2,
and a+b=3,
is added to the component A) and/or B) or to the mixture of A) and B).

We have also found catalyst systems obtainable by this process, the use of the catalyst systems for the polymerization of olefins and a process for preparing polyolefins in which these catalyst systems are used.

The catalyst systems prepared according to the invention are suitable for the polymerization of olefins and especially for the polymerization of a-olefins, i.e. hydrocarbons having terminal double bonds. Suitable monomers can also be functionalized olefinically unsaturated compounds such as ester or amide derivatives of acrylic or methacrylic acid, for example acrylates, methacrylates or acrylonitrile. Preference is given to nonpolar olefinic compounds, including aryl-substituted α-olefins. Particularly preferred α-olefins are linear or branched C₂-C₁₂-1-alkenes, in particular linear C₂-C₁₀-1-alkenes such as ethene, propene, 1-butene, 1-pentene, 1-hexene, 1-heptene, 1-octene, 1-decene or branched C₅-C₁₀-1-alkenes such as 4-methyl-1-pentene, conjugated and unconjugated dienes such as 1,3-butadiene, 1,4-hexadiene or 1,7-octadiene or vinylaromatic compounds such as styrene or substituted styrene. It is also possible to polymerize mixtures of various α-olefins.

Suitable olefins also include olefins in which the double bond is part of a cyclic structure which may comprise one or more ring systems. Examples are cyclopentene, norbornene, tetracyclododecene and methyinorbornene and dienes such as 5-ethylidene-2-norbornene, norbornadiene and ethylnorbornadiene.

It is also possible to polymerize mixtures of two or more olefins.

In particular, the catalysts of the invention can be used for the polymerization or copolymerization, preferably homopolymerization, of ethene.

Component A) is a complex of a transition metal of groups 8 to 10 of the Periodic Table of the Elements. Possible components A) are, in particular, complexes having Fe, Co, Ni or Pd as central atom.

Examples of such complexes of a transition metal, hereinafter also referred to as transition metal complexes, are, in particular, cyclopentadienyl-free compounds having at least one ligand of the general formulae (IIa) to (IIe),

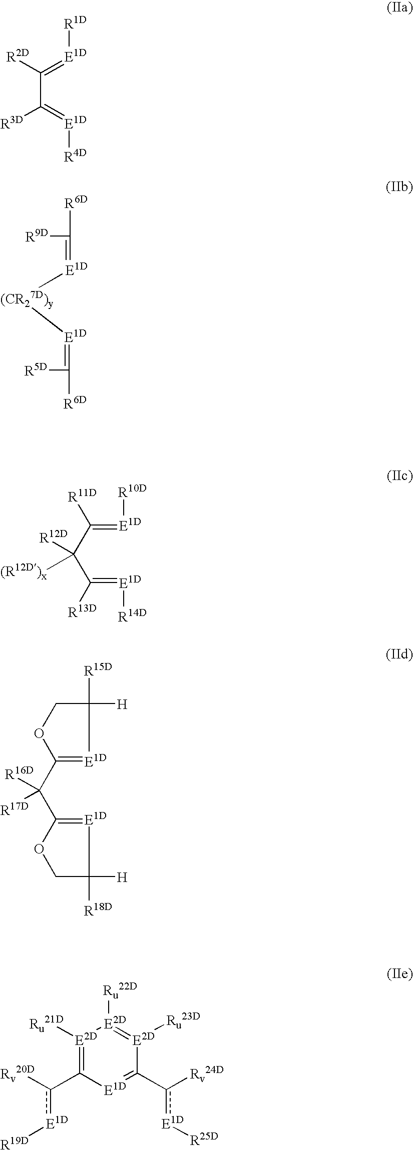

where the central atom of the complex is selected from among the elements of groups 8 to 10 of the Periodic Table of the Elements. Preference is given to compounds having iron, cobalt, nickel or palladium as central atom.

The atoms E^{1D} are identical or different and are each atoms of an element of group 15 of the Periodic Table of the Elements, preferably N or P, in particular N.

The atoms E^{2D} in formula (IIe) are each, independently of one another, carbon, nitrogen or phosphorus, in particular carbon.

The radicals R^{1D} to R^{25D}, which may be identical or different within a ligand system (IIa) to (IIe), are as follows:
R^{1D} and R^{4D} are independent of one another and are each an organic radical which has from 1 to 40 carbon atoms and is bound via a carbon atom, for example C₁-C₁₀-alkyl, 5- to 7-membered cycloalkyl or cycloalkenyl, C₂-C₂₂-alkenyl, C₆-C₄₀-aryl, alkylaryl or arylalkyl each having from 1 to 10 carbon atoms in the alkyl radical and from 6 to 20 carbon atoms in the aryl radical, where the organic radicals R^{1D} and R^{4D} may also be substituted by halogens and the carbon atom bound to E^{1D} is preferably joined to at least two further carbon atoms.
R^{2D} and R^{3D} are independent of one another and are each hydrogen or an organic radical which has from 1 to 40 carbon atoms and is bound via a carbon atom, for example C₁-C₁₀-alkyl, 5- to 7-membered cycloalkyl or cycloalkenyl, C₂-C₂₂-alkenyl, C₆-C₄₀-aryl, alkylaryl or arylalkyl each having from 1 to 10 carbon atoms in the alkyl radical and from 6 to 20 carbon atoms in the aryl radical, where the organic radicals R^{2D} and R^{3D} may also be substituted by halogens and R^{2D} and R^{3D} may also together form a ring system in which one or more heteroatoms may be present.
   Adjacent radicals R^{1D} to R^{4D}, in particular R^{1D} with R^{2D} and R^{3D} with R^{4D}, together with the atoms connecting them can also form saturated or unsaturated, substituted or unsubstituted, five- or six-membered ring systems.
R^{5D} to R^{9D} are independent of one another and are each hydrogen or an organic radical which has from 1 to 40 carbon atoms and is bound via a carbon atom, for example C₁-C₁₀-alkyl, 5- to 7-membered cycloalkyl or cycloalkenyl, C₂-C₂₂-alkenyl, C₆-C₄₀-aryl, alkylaryl or arylalkyl each having from 1 to 10 carbon atoms in the alkyl radical and from 6 to 20 carbon atoms in the aryl radical, where the organic radicals R^{5D} to R^{9D} may also be substituted by halogens and R^{6D} and R^{5D} or R^{8D} and R^{9D} or two radicals R^{7D} may together form a ring system.
R^{10D} and R^{14D} are independent of one another and are each an organic radical which has from 1 to 40 carbon atoms and is bound via a carbon atom, for example C₁-C₁₀-alkyl, 5- to 7-membered cycloalkyl or cycloalkenyl, C₂-C₂₂-alkenyl, C₆-C₄₀-aryl, alkylaryl or arylalkyl each having from 1 to 10 carbon atoms in the alkyl radical and from 6 to 20 carbon atoms in the aryl radical, where the organic radicals R^{10D} and R^{14D} may also be substituted by halogens.
R^{11D}, R^{12D}, R^{12D′} and R^{13D} are independent of one another and are each hydrogen or an organic radical which has from 1 to 40 carbon atoms and is bound via a carbon atom, for example C₁-C₁₀-alkyl, 5- to 7-membered cycloalkyl or cycloalkenyl, C₂-C₂₂-alkenyl, C₆-C₄₀-aryl, alkylaryl or arylalkyl each having from 1 to 10 carbon atoms in the alkyl radical and from 6 to 20 carbon atoms in the aryl radical, where the organic radicals R^{11D}, R^{12D}, R^{12D′} and R^{13D} may also be substituted by halogens and two or more geminal or vicinal radicals R^{11D}, R^{12D}, R^{12D′} and R^{13D} may together form a ring system.
R^{15D} to R^{18D} are independent of one another and are each hydrogen, SiR^{26D}₃ or a an organic radical which has from 1 to 40 carbon atoms and is bound via a carbon atom, for example C₁-C₁₀-alkyl, 5- to 7-membered cycloalkyl or cycloalkenyl, C₂-C₂₂-alkenyl, C₆-C₄₀-aryl, arylalkyl having from 1 to 10 carbon atoms in the alkyl radical and from 6 to 20 carbon atoms in the aryl radical, where the organic radicals R^{15D}-R^{18D} may also be substituted by halogens and two vicinal radicals R^{15D}-R^{18D} may also be joined to form a five- or six-membered ring.
R^{19D} and R^{25D} are independent of one another and are each C₆-C₄₀-aryl or alkylaryl having from 1 to 10 carbon atoms in the alkyl radical and from 6 to 20 carbon atoms in the aryl radical or —NR^{26D}₂, where the radicals R^{19D} and R^{25D} may also be substituted by halogens or an Si—, N—, P—, O— or S-containing group.
R^{20D} to R^{24D} are independent of one another and are each hydrogen, halogen, —OR^{26D}, —NR^{26D}₂, —SiR^{26D}₃ or an organic radical which has from 1 to 40 carbon atoms and is bound via a carbon atom, for example C₁-C₁₀-alkyl, 5- to 7-membered cycloalkyl or cycloalkenyl, C₂-C₂₂-alkenyl, C₆-C₄₀-aryl, alkylaryl or arylalkyl having from 1 to 10 carbon atoms in the alkyl radical and from 6 to 20 carbon atoms in the aryl radical, where the organic radicals R^{20D} to R^{24D} may also be substituted by halogens and/or two geminal or vicinal radicals R^{20D} to R^{24D} may also be joined to form a five-, six- or seven-membered ring and/or two geminal or vicinal radicals R^{20D} to R^{24D} are joined to form a five-, six- or seven-membered heterocycle containing at least one atom from the group consisting of N, P, O and S.
The radicals R^{26D} are independent of one another and are each hydrogen or an organic radical which has from 1 to 40 carbon atoms and is bound via a carbon atom, for example C₁-C₂₀-alkyl, 5- to 7-membered cycloalkyl or cycloalkenyl, C₂-C₂₀-alkenyl, C₆-C₄₀-aryl, alkylaryl or arylalkyl having from 1 to 10 carbon atoms in the alkyl radical and from 6 to 20 carbon atoms in the aryl radical, where two radicals R^{26D} may also be joined to form a five- or six-membered ring.
The indices u are independent of one another and are each 0 when E^{2D} is nitrogen or phosphorus and 1 when E^{2D} is carbon.
The indices v are independent of one another and are each 1 or 2, with in the case of v=1 the bond between the carbon which then bears a radical and the adjacent element E^{1D} being a double bond and in the case of v=2 the bond between the carbon which then bears two radicals and the adjacent element E^{1D} being a single bond.
x is 0 or 1, with the ligand of the formula (IIc) being negatively charged when x=0.
y is an integer from 1 to 4, preferably 2 or 3.

Furthermore, the substituents according to the present invention are, unless restricted further, defined as follows:

The term “organic radical which has from 1 to 40 carbon atoms” as used in the present text refers, for example, to C₁-C₄₀-alkyl radicals, C₁-C₁₀-fluoroalkyl radicals, C₁-C₁₂-alkoxy radicals, saturated C₃-C₂₀-heterocyclic radicals, C₆-C₄₀-aryl radicals, C₂-C₄₀-heteroaromatic radicals, C₆-C₁₀-fluoroaryl radicals, C₆-C₁₀-aryloxy radicals, C₃-C₁₈-trialkylsilyl radicals, C₂-C₂₀-alkenyl radicals, C₂-C₂₀-alkynyl radicals, C₇-C₄₀-arylalkyl radicals, C₇-C₄₀-fluoroalkylaryl radicals or C₈-C₄₀-arylalkenyl radicals. An organic radical is in each case derived from an organic compound. Thus, the organic compound methanol in principle gives rise to three different organic radicals having one carbon atom, namely methyl (H₃C—), methoxy (H₃C—O—) and hydroxymethyl (HOC(H₂)—).

The term “alkyl” as used in the present text encompasses linear or singly or multiply branched saturated hydrocarbons which may also be cyclic. Preference is given to C₁-C₁₈-alkyl such as methyl, ethyl, n-propyl, n-butyl, n-pentyl, n-hexyl, n-heptyl, n-octyl, n-nonyl, n-decyl, cyclopentyl, cyclohexyl, isopropyl, isobutyl, isopentyl, isohexyl, sec-butyl or tert-butyl.

The term “alkenyl” as used in the present text encompasses linear or singly or multiply branched hydrocarbons having one or more C—C double bonds which may be cumulated or alternating.

The term “saturated heterocyclic radical” as used in the present text refers, for example, to monocyclic or polycyclic, substituted or unsubstituted hydrocarbon radicals in which one or more carbon atoms, CH groups and/or CH₂ groups have been replaced by heteroatoms preferably selected from the group consisting of O, S, N and P. Preferred examples of substituted or unsubstituted saturated heterocyclic radicals are pyrrolidinyl, imidazolidinyl, pyrazolidinyl, piperidyl, piperazinyl, morpholinyl, tetrahydrofuranyl, tetrahydropyranyl, tetrahydrothiophenyl and the like, and also methyl-, ethyl-, propyl-, isopropyl- and tert-butyl-substituted derivatives thereof.

The term “aryl” as used in the present text refers, for example, to aromatic and optionally fused polyaromatic hydrocarbon substituents which may be monosubstituted or polysubstituted by linear or branched C₁-C₁₈-alkyl, C₁-C₁₈-alkoxy, C₂-C₁₀-alkenyl or halogen, in particular fluorine. Preferred examples of substituted and unsubstituted aryl radicals are, in particular, phenyl, pentafluorophenyl, 4-methylphenyl, 4-ethylphenyl, 4-n-propylphenyl, 4-isopropylphenyl, 4-tert-butylphenyl, 4-methoxyphenyl, 1-naphthyl, 9-anthryl, 9-phenanthryl, 3,5-dimethylphenyl, 3,5-di-tert-butylphenyl or 4-trifluoromethylphenyl.

The term “heteroaromatic radical” as used in the present text refers, for example, to aromatic hydrocarbon radicals in which one or more carbon atoms have been replaced by nitrogen, phosphorous, oxygen or sulfur atoms or combinations thereof. Like the aryl radicals, these may be monosubstituted or polysubstituted by linear or branched C₁-C₁₈-alkyl, C₂-C₁₀-alkenyl or halogen, in particular fluorine. Preferred examples are furyl, thienyl, pyrrolyl, pyridyl, pyrazolyl, imidazolyl, oxazolyl, thiazolyl, pyrimidinyl, pyrazinyl and the like, and also methyl-, ethyl-, propyl-, isopropyl- and tert-butyl-substituted derivatives thereof.

The term “arylalkyl”, as used in the present text refers, for example, to aryl-containing substituents whose aryl radical is joined via an alkyl chain to the remainder of the molecule. Preferred examples are benzyl, substituted benzyl, phenethyl, substituted phenethyl and the like.

The expressions fluoroalkyl and fluoroaryl mean that at least one hydrogen atom, preferably a plurality of and at most all hydrogen atoms, of the respective substituent have been replaced by fluorine atoms. Examples of fluorine-containing substituents which are preferred according to the invention are trifluoromethyl, 2,2,2-trifluoroethyl, pentafluorophenyl, 4-trifluoromethylphenyl, 4-perfluoro-tert-butylphenyl and the like.

Particularly useful transition metal complexes are complexes having Fe, Co, Ni, Pd or Pt as central metal and ligands of the formula (IVa), in particular diimine complexes of Ni or Pd, for example:

di(2,6-di-i-propylphenyl)-2,3-dimethyidiazabutadienepalladium dichloride,

di(2,6-di-i-propylphenyl)-2,3-dimethyldiazabutadienenickel dichloride,

di(2,6-di-i-propylphenyl)dimethyldiazabutadienedimethylpalladium,

di(2,6-di-i-propylphenyl)-2,3-dimethyldiazabutadienedimethylnickel,

di(2,6-dimethylphenyl)-2,3-dimethyldiazabutadienepalladium dichloride,

di(2,6-dimethylphenyl)-2,3-dimethyldiazabutadienenickel dichloride,

di(2,6-dimethylphenyl)-2,3-dimethyidiazabutadienedimethylpalladium,

di(2,6-dimethylphenyl)-2,3-dimethyidiazabutadienedimethylnickel,

di(2-methylphenyl)-2,3-dimethyidiazabutadienepalladium dichloride,

di(2-methylphenyl)-2,3-dimethyldiazabutadienenickel dichloride,

di(2-methylphenyl)-2,3-dimethyidiazabutadienedimethylpalladium,

di(2-methylphenyl)-2,3-dimethyldiazabutadienedimethylnickel,

diphenyl-2,3-dimethyidiazabutadienepalladium dichloride,

diphenyl-2,3-dimethyldiazabutadienenickel dichloride,

diphenyl-2,3-dimethyldiazabutadienedimethylpalladium,

diphenyl-2,3-dimethyldiazabutadienedimethylnickel,

di(2,6-dimethylphenyl)azanaphthenepalladium dichloride,

di(2,6-dimethylphenyl)azanaphthenenickel dichloride,

di(2,6-dimethylphenyl)azanaphthenedimethylpalladium,

di(2,6-dimethylphenyl)azanaphtenedimethylnickel,

1,1′-bipyridylpalladium dichloride,

1,1′-bipyridylnickel dichloride,

1,1′-bipyridyldimethylpalladium,

1,1′-bipyridyldimethylnickel.

Transition metal complexes which are likewise particularly useful are complexes having ligands of the formula (IIe) as are described in J. Am. Chem. Soc. 120, p. 4049 ff. (1998), J. Chem. Soc., Chem. Commun. 1998, 849 and WO 98/27124. E^{D} is preferably nitrogen and R^{19D} and R^{25D} in the ligand of the formula (IIe) are preferably phenyl, naphthyl, biphenyl, anthranyl, o-, m-, p-methylphenyl, 2,3-, 2,4-, 2,5- or 2,6-dimethylphenyl, -dichlorophenyl or -dibromophenyl, 2-chloro-6-methylphenyl, 2,3,4-, 2,3,5-, 2,3,6-, 2,4,5-, 2,4,6- or 3,4,5-trimethylphenyl, in particular 2,3- or 2,6-dimethylphenyl, -diisopropylphenyl, -dichlorophenyl or -dibromophenyl and 2,4,6-trimethylphenyl. At the same time, R^{20D} and R^{24D} are preferably hydrogen, methyl, ethyl, n-propyl, isopropyl, n-butyl, tert-butyl, n-pentyl, n-hexyl, n-heptyl, n-octyl, benzyl or phenyl, in particular hydrogen or methyl. R^{21D} and R^{23D} are preferably hydrogen and R^{22D} is preferably hydrogen, methyl, ethyl or phenyl, in particular hydrogen.

In the process of the invention for preparing a catalyst, the complex A) is preferably an iron compound.

Very particular preference is given to iron compounds of the general formula (III)

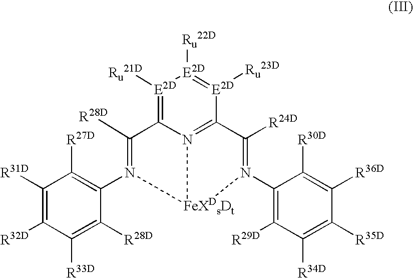

where
the atoms E^{2D} are each, independently of one another, carbon, nitrogen or phosphorus, in particular carbon,
R^{20D} and R^{24D} are each, independently of one another, hydrogen, halogen, —OR^{26D}, —NR^{26D}₂, —SiR^{26D}₃ or an organic radical which has from 1 to 40 carbon atoms and is bound via a carbon atom, for example C₁-C₂₀-alkyl, 5- to 7-membered cycloalkyl or cycloalkenyl, C₂-C₂₂-alkenyl, C₆-C₄₀-aryl, alkylaryl or arylalkyl having from 1 to 10 carbon atoms in the alkyl radical and from 6 to 20 carbon atoms in the aryl radical, where the organic radicals R^{20D} and R^{24D} may also be substituted by halogens,
R^{21D} to R^{23D} are each, independently of one another, hydrogen, halogen, —OR^{26D}, —NR^{26D}₂, —SiR^{26D}₃ or an organic radical which has from 1 to 40 carbon atoms and is bound via a carbon atom, for example C₁-C₂₀-alkyl, 5- to 7-membered cycloalkyl or cycloalkenyl, C₂-C₂₂-alkenyl, C₆-C₄₀-aryl, alkylaryl or arylalkyl having from 1 to 10 carbon atoms in the alkyl radical and from 6 to 20 carbon atoms in the aryl radical, where the organic radicals R^{21D} to R^{23D} may also be substituted by halogens and/or two vicinal radicals R^{21D} to R^{23D} may also be joined to form a five-, six- or seven-membered ring, and/or two vicinal radicals R^{21D} to R^{23D} are joined to form a five-, six- or seven-membered heterocycle containing at least one atom from the group consisting of N, P,O and S,
the indices u are each, independently of one another, 0 when E^{2D} is nitrogen or phosphorus and 1 when E^{2D} is carbon,
R^{27D} to R^{30D} are each, independently of one another, —NR^{26D}₂, —OR^{26D}, —SiR²⁶⁰₃, halogen or an organic radical which has from 1 to 40 carbon atoms and is bound via a carbon atom, for example C₁-C₂₀-alkyl, 5- to 7-membered cycloalkyl or cycloalkenyl, C₂-C₂₂-alkenyl, C₆-C₄₀-aryl, alkylaryl or arylalkyl having from 1 to 10 carbon atoms in the alkyl radical and from 6 to 20 carbon atoms in the aryl radical, where the organic radicals R^{27D} to R^{30D} may also be substituted by halogens,
R^{31D} to R^{36D} are each, independently of one another, hydrogen —NR^{26D}₂, —OR^{26D}, —SiR^{26D}₃, halogen or an organic radical which has from 1 to 40 carbon atoms and is bound via a carbon atom, for example C₁-C₂₀-alkyl, 5- to 7-membered cycloalkyl or cycloalkenyl, C₂-C₂₂-alkenyl, C₆-C₄₀-aryl, alkylaryl or arylalkyl having from 1 to 10 carbon atoms in the alkyl radical and from 6 to 20 carbon atoms in the aryl radical, where the organic radicals R^{31D} to R^{36D} may also be substituted by halogens,
   and/or two vicinal radicals R^{27D} to R^{36D} may also be joined to form a five-, six- or seven-membered carbocycle, and/or two vicinal radicals R^{27D} to R^{36D} may also be joined to form a five-, six- or seven-membered heterocycle containing at least one atom from the group consisting of N, P, O and S,
the radicals X^{D} are each, independently of one another, fluorine, chlorine, bromine, iodine, hydrogen, C₁-C₁₀-alkyl, C₂-C₁₀-alkenyl, C₆-C₄₀-aryl, arylalkyl having from 1 to 10 carbon atoms in the alkyl radical and from 6 to 20 carbon atoms in the aryl radical, —NR_{26D}₂, —OR^{26D}, —SR^{26D}, —SO₃R^{26D}, —O—C(O)—R^{26D}, —CN, —SCN, β-diketonate, CO, BF₄⁻, PF₆⁻ or a bulky noncoordinating anion or two radicals X^{D} may be joined to one another,
the radicals R^{26D} are each, independently of one another, hydrogen or an organic radical which has from 1 to 40 carbon atoms and is bound via a carbon atom, for example C₁-C₂₀-alkyl, C₂-C₂₀-alkenyl, C₆-C₂₀-aryl, alkylaryl or arylalkyl having from 1 to 10 carbon atoms in the alkyl radical and from 6 to 20 carbon atoms in the aryl radical, where the organic radicals R^{26D} may also be substituted by halogens or nitrogen- and oxygen-containing groups and two radicals R^{26D} may also be joined to form a five- or six-membered ring,
s is 1, 2, 3 or 4, in particular 2 or 3,
D is an uncharged donor and
t is from 0 to 4, in particular 0, 1 or 2.

Particular preference is given to

2,6-diacetylpyridinebis(2,6-dimethylphenylimine)iron dichloride,

2,6-diacetylpyridinebis(2,4,6-trimethylphenylimine)iron dichloride,

2,6-diacetylpyridinebis(2-chloro-6-methylphenylimine)iron dichloride,

2,6-diacetylpyridinebis(2,6-diisopropylphenylimine)iron dichloride,

2,6-diacetylpyridinebis(2,6-dichlorophenylimine)iron dichloride,

2,6-pyridinedicarboxaldehydebis(2,6-diisopropylphenylimine)iron dichloride,

2,6-diacetylpyridinebis(2,4-dimethylphenylimine)cobalt dichloride,

2,6-diacetylpyridinebis(2,4,6-trimethylphenylimine)cobalt dichloride,

2,6-diacetylpyridinebis(2-chloro-6-methylphenylimine)cobalt dichloride,

2,6-diacetylpyridinebis(2,6-diisopropylphenylimine)cobalt dichloride,

2,6-diacetylpyridinebis(2,6-dichlorophenylimine)cobalt dichloride,

2,6-pyridinedicarboxaldehydebis(2,6-diisopropylphenylimine)cobalt dichloride,

2,6-diacetylpyridinebis(2,6-difluorophenylimine)iron dichloride and

2,6-diacetylpyridinebis(2,6-dibromophenylimine)iron dichloride.

As aluminoxanes, it is possible to use, for example, the compounds described in WO 00/31090 in the process of the invention. Particularly useful aluminoxanes are open-chain or cyclic aluminoxane compounds of the general formula (IV) or (V)

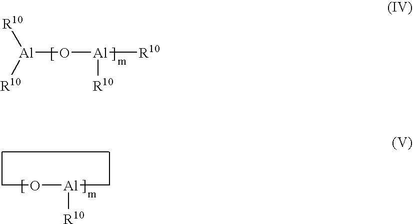

where
R₁₀ is a C₁-C₄-alkyl group, preferably a methyl or ethyl group, in particular a methyl group, and m is an integer from 5 to 30, preferably from 10 to 25.

These oligomeric aluminoxane compounds are usually prepared by reaction of a solution of trialkylaluminum with water. In general, the oligomeric aluminoxane compounds obtained in this way are in the form of mixtures of both linear and cyclic chain molecules of various lengths, so that m is to be regarded as a mean. The aluminoxane compounds can also be present in a mixture with other metal alkyls, preferably aluminum alkyls.

Furthermore, modified aluminoxanes in which some of the hydrocarbon radicals or hydrogen atoms have been replaced by alkoxy, aryloxy, siloxy or amide radicals can also be used in place of the aluminoxane compounds of the general formulae (IV) or (V).

Particular preference is given to methylaluminoxanes as component B).

It has been found to be advantageous to use the transition metal compound A) and the aluminoxane compound B) in such amounts that the atomic ratio of aluminum from the aluminoxane compound and the transition metal from the transition metal compound B) is in the range from 10:1 to 10⁶:1, preferably in the range from 20:1 to 10⁴:1 and in particular in the range from 50:1 to 5000:1.

The boron compound C) is a compound of the formula (I)
(R¹)ₐ—B—(OR²)_{b} (I)

R¹ is an organic radical having from 1 to 40 carbon atoms, for example a cyclic, branched or unbranched C₁-C₂₀—, preferably C₁-C₈-alkyl radical, which may bear halogen atoms, in particular fluorine or chlorine, or C₁-C₁₀-alkoxy groups as substituents, a C₂-C₂₀—, preferably C₂-C₈-alkenyl radical, a branched or preferably linear alkoxy radical having from 1 to 10, preferably from 1 to 4, carbon atoms, a substituted or unsubstituted C₆-C₄₀-aryl radical, an arylalkyl, arylalkenyl or alkylaryl radical having from 1 to 10, preferably from 1 to 4, carbon atoms in the alkyl radical and from 6 to 22, preferably from 6 to 10, carbon atoms in the aryl radical, a saturated heterocycle having from 2 to 40 carbon atoms or a C₂-C₄₀-heteroaromatic radical having in each case at least one heteroatom selected from the group consisting of the elements O, N, S, P and Se, in particular O, N and S, with the heteroaromatic radical being able to be substituted by further radicals R³, where R³ is an organic radical having from 1 to 20 carbon atoms, for example C₁-C₁₀—, preferably C₁-C₄-alkyl, C₆-C₁₅—, preferably C₆-C₁₀-aryl, alkylaryl, arylalkyl, fluoroalkyl or fluoroaryl each having from 1 to 10, preferably from 1 to 4, carbon atoms in the alkyl radical and from 6 to 18, preferably from 6 to 10, carbon atoms in the aryl radical, and a plurality of radicals R³ may be identical or different.

R¹ is preferably a substituted or unsubstituted C₆-C₄₀-aryl or alkylaryl radical having from 1 to 10, preferably from 1 to 4, carbon atoms in the alkyl radical and from 6 to 22, preferably from 6 to 10, carbon atoms in the aryl radical, with the radicals also being able to be halogenated. Examples of particularly preferred radicals R¹ are phenyl, 2-tolyl, 3-tolyl, 4-tolyl, 2,3-dimethylphenyl, 2,4-dimethylphenyl, 2,5-dimethylphenyl, 2,6-dimethylphenyl, 3,4-dimethylphenyl, 3,5-dimethylphenyl, 3,5-di(tert-butyl)phenyl, 2,4,6-trimethylphenyl, 2,3,4-trimethylphenyl, 1-naphthyl, 2-naphthyl, phenanthrenyl, p-isopropylphenyl, p-tert-butylphenyl, p-s-butylphenyl, p-cyclohexylphenyl, p-trimethylsilylphenyl, 2-fluorophenyl, 3-fluorophenyl, 4-fluorophenyl, 2,3-difluorophenyl, 2,4-difluorophenyl, 2,5-difluorophenyl, 2,6-difluorophenyl, 3,4-difluorophenyl, 3,5-difluorophenyl, 2-(trifluoromethyl)phenyl, 3-(trifluoromethyl)phenyl, 4-(trifluoromethyl)phenyl, 3,5-bis(trifluoromethyl)phenyl and pentafluorophenyl, in particular phenyl, 2-tolyl, 4-tolyl, 2-fluorophenyl, 4-fluorophenyl, 3,5-bis(trifluoromethyl)phenyl and pentafluorophenyl.

R² is hydrogen or an organic radical which has from 1 to 40 carbon atoms and is bound via a carbon atom, for example a cyclic, branched or unbranched C₁-C₂₀—, preferably C₁-C₈-alkyl radical which may bear halogen atoms, in particular fluorine or chlorine, or C₁-C₁₀-alkoxy groups as substituents, a C₂-C₂₀—, preferably C₂-C₈-alkenyl radical, a substituted or unsubstituted C₆-C₄₀-aryl radical, an arylalkyl, arylalkenyl or alkylaryl radical having from 1 to 10, preferably from 1 to 4, carbon atoms in the alkyl radical and from 6 to 22, preferably from 6 to 10, carbon atoms in the aryl radical, a saturated heterocycle having from 2 to 40 carbon atoms or a C₂-C₄₀-heteroaromatic radical having in each case at least one heteroatom selected from the group consisting of the elements O, N, S, P and Se, in particular O, N and S, with the heteroaromatic radical being able to be substituted by further radicals R³, where R³ is an organic radical having from 1 to 20 carbon atoms, for example C₁-C₁₀—, preferably C₁-C₄-alkyl, C₆-C₁₅—, preferably C₆-C₁₀-aryl, alkylaryl, arylalkyl, fluoroalkyl or fluoroaryl each having from 1 to 10, preferably from 1 to 4, carbon atoms in the alkyl radical and from 6 to 18, preferably from 6 to 10, carbon atoms in the aryl radical, and a plurality of radicals R³ may be identical or different. Two radicals R² together with the atoms connecting them can also form a cyclic system.

R² is preferably hydrogen.

a is 1 or 2, preferably 1.

b is 1 or 2, preferably 2.

In the process of the invention, preference is given to using boronic acids having aromatic radicals as component C), in particular those having substituted aromatic hydrocarbon radicals which are substituted by halogen atoms or alkyl radicals, in particular by fluorine, methyl or trifluoromethyl radicals.

It has found to be advantageous to use the boron compound C) and the aluminoxane compound B) in such amounts that the atomic ratio of aluminum from the aluminoxane compound B) to the boron from the boron compound C) is in the range from 1:10⁻⁴ to 1:1, preferably in the range from 1:10⁻³ to 1:0.5 and particularly preferably in the range from 1:0.002 to 1:0.05.

In the process of the invention, the catalyst system is obtained by bringing the components A) and B) into contact with one another, with the component C) being added to the components A) and/or B) or to the mixture of A) and B). The order in which the components are brought into contact with one another is in principle immaterial. It is usual firstly to bring A) into contact with B) and subsequently to add the component C) to this mixture. However, it is also possible for B) to be mixed with C) first and the component A) to be added subsequently. The components are usually combined in the presence of an organic solvent. Suitable solvents are aromatic or aliphatic hydrocarbons, for example hexane, heptane, toluene or xylene, or halogenated hydrocarbons such as methylene chloride or halogenated aromatic hydrocarbons such as o-dichlorobenzene.

Preference is given to a process in which the boron compound of the formula (I) is added to a solution comprising A) and B).

The components are generally combined at temperatures in the range from −20° C. to 150° C., preferably in the range from 0° C. to 100° C. When not all of the components are combined simultaneously, the temperature in the individual steps in which the components are combined can be identical in each case. However, the temperatures of the individual steps can also be different.

The time for which the components which have been brought into contact are allowed to react with one another is generally from 1 minute to 48 hours. Preference is given to reaction times of from 10 minutes to 6 hours. When the components are brought into contact in a stepwise fashion, the reaction times for the individual steps are usually from 1 minute to 6 hours, preferably from 10 minutes to 2 hours.

In a preferred embodiment of the process of the invention, at least one support is added as further component D) in the preparation of a catalyst system for olefin polymerization.

Preference is given to finely divided supports which can be any organic or inorganic, inert solid. In particular, the support component D) can be a magnesium chloride support or a porous support such as talc, a sheet silicate, an inorganic oxide or a finely divided polymer powder.

Inorganic oxides suitable as supports may be found among the oxides of elements of groups 2, 3, 4, 5, 13, 14, 15 and 16 of the Periodic Table of the Elements. Preference is given to oxides or mixed oxides of the elements calcium, aluminum, silicon, magnesium or titanium and also corresponding oxide mixtures. Other inorganic oxides which can be used alone or in combination with the abovementioned oxidic supports are, for example, ZrO₂ or B₂O₃. Preferred oxides are silicon dioxide, in particular in the form of a silica gel or a pyrogenic silica, or aluminum oxide. A preferred mixed oxide is, for example, calcined hydrotalcite.

The support materials used preferably have a specific surface area in the range from 10 to 1000 m²/g, preferably from 50 to 500 m²/g and in particular from 200 to 400 m²/g, and a pore volume in the range from 0.1 to 5 ml/g, preferably from 0.5 to 3.5 ml/g and in particular from 0.8 to 3.0 ml/g. The mean particle size of the finely divided support is generally in the range from 1 to 500 μm, preferably from 5 to 350 μm and in particular from 10 to 100 μm.

The inorganic support can be subjected to a thermal treatment, e.g. to remove adsorbed water. Such a drying treatment is generally carried out at temperatures in the range from 80 to 300° C., preferably from 100 to 200° C., with drying preferably being carried out under reduced pressure and/or in a stream of inert gas, for example nitrogen or argon. The inorganic support can also be calcined, in which case the concentration of the OH groups on the surface is set and the structure of the solid may be altered by treatment at temperatures of from 200 to 1000° C. The support can also be treated chemically using customary dessicants such as metal alkyls, preferably aluminum alkyls, chlorosilanes or SiCl₄, or else methylaluminoxane. Appropriate treatment methods are described, for example, in WO 00/31090.

The inorganic support materials can also be chemically modified. For example, treatment of silica gel with (NH₄)₂SiF₆ leads to fluorination of the silica gel surface, or treatment of silica gels with silanes containing nitrogen-, fluorine- or sulfur-containing groups gives correspondingly modified silica gel surfaces.

Further possible support materials are finely divided polymer powders, for example polyolefins such as polyethylene or polypropylene or polystyrene. They should preferably be freed of adhering moisture, solvents residues or other impurities by appropriate purification and drying preparations before use. It is also possible to use functionalized polymer supports, e.g. one based on polystyrenes, via whose functional groups, for example ammonium or hydroxyl groups, at least one of the catalyst components can be fixed.

In the preparation of the supported catalyst system, the order in which components A), B), C) and D) are combined is in principle immaterial. The transition metal compound A), the aluminoxane B) and the boron compound C) can be immobilized independently of one another or simultaneously. After the individual process steps, the solid can be washed with suitable inert solvents such as aliphatic or aromatic hydrocarbons.

However, preference is given to preparing the unsupported catalyst system first as solution or suspension, preferably as solution, by bringing the components A), B) and C) into contact with one another. The preparation obtained in this way is then mixed with the dehydrated or passivated support material D), the solvent is removed and the resulting supported catalyst system comprising a transition metal compound is dried to ensure that all or most of the solvent is removed from the pores of the support material. The supported catalyst is obtained as a free-flowing powder.

When a support D) is used, it is possible for the catalyst solid firstly to be prepolymerized with α-olefins, preferably linear C₂-C₁₀-1-alkenes and in particular ethene or propene, and the resulting prepolymerized catalyst solid then to be used in the actual polymerization. The molar ratio of catalyst solid used in the prepolymerization to monomer to be polymerized onto it is usually in the range from 1:0.1 to 1:200.

Furthermore, a small amount of an olefin, preferably an α-olefin, for example vinylcyclohexane, styrene or phenyldimethylvinylsilane, as modifying component, an antistat or a suitable inert compound such as a wax or oil can be added as additive during or after the preparation of a supported catalyst. The molar ratio of additives to organic transition metal compounds A) is usually from 1:1000 to 1000:1, preferably from 1:5 to 20:1.

The invention further provides the catalyst system obtained by the process of the invention.

The catalyst system of the invention, which comprises at least one transition metal compound A), an aluminoxane B) and a boron compound C) and possibly a support, can be used either alone or together with one or more further catalyst systems which can likewise be supported and are suitable for the homopolymerization, copolymerization or oligomerization of olefins in a polymerization process. Here, the further catalyst system or systems can be prepared independently of the catalyst system of the invention or can be produced together with this. The different catalyst systems can thus, for example, be present together on a support or they can be present independently of one another as supported or unsupported catalyst systems which can be premixed in any way and thus introduced together or separately and thus independently of one another into the polymerization reactor. Examples of known catalyst systems which can be used together with the catalyst system of the invention for preparing polyolefins are, in particular, classical Ziegler-Natta catalysts based on titanium, classical Phillips catalysts based on chromium oxides or single-site catalysts which preferably comprise metallocenes, viz. constrained geometry complexes (cf., for example, EP A 0 416 815 or EP A 0 420 436), or chromium single-site complexes as described, for example, in U.S. Pat. No. 6,437,161, as transition metal components. If the catalyst system of the invention is used together with at least one further catalyst for the polymerization, then preference is given to using a single-site catalyst, in particular ones based on a metallocene complex and/or a chromium single-site complex.

The invention further provides firstly for the use of a catalyst system according to the invention as described above for preparing polyolefins and secondly a process for preparing polyolefins by polymerization or copolymerization of at least one olefin in the presence of a catalyst system according to the invention as described above.

In general, the catalyst system of the invention is used together with a further organometallic compound of the formula (VI)
M¹(R¹¹)_{c}(R¹²)_{c}(R¹³)ₑ (VI)

where
M¹ is an alkali metal, an alkaline earth metal or a metal of group 13 of the Periodic Table, i.e. boron, aluminum, gallium, indium or thallium, preferably lithium, magnesium or aluminum,
R¹¹ is hydrogen, C₁-C₁₀-alkyl, C₆-C₁₅-aryl, alkylaryl or arylalkyl each having from 1 to 10 carbon atoms in the alkyl radical and from 6 to 20 carbon atoms in the aryl radical,
R¹² and R¹³ are identical or different and are each hydrogen, halogen, C₁-C₁₀-alkyl, C₆-C₁₅-aryl, alkylaryl, arylalkyl or alkoxy each having from 1 to 10 carbon atoms in the alkyl radical and from 6 to 20 carbon atoms in the aryl radical,
c is an integer from 1 to 3,
and
d and e are integers from 0 to 2, with the sum c+d+e corresponding to the valence of M¹,

for the polymerization or copolymerization of olefins.

It is also possible to use mixtures of various organometallic compounds of the formula (VI).

Among the organometallic compounds of the formula (VI), preference is given to those in which
M¹ is lithium, magnesium or aluminum and
R¹² and R¹³ are each C₁-C₁₀-alkyl.

Particularly preferred metal compounds of the formula (VI) are n-butyllithium, n-butyl-n-octylmagnesium, n-butyl-n-heptylmagnesium, isoprenylaluminum, tri-n-hexylaluminum, triisobutylaluminum, triethylaluminum and trimethylaluminum and mixtures thereof.

The organometallic compound of the formula (VI) is generally added to the monomer or the suspension medium and serves to free the monomer of substances which can adversely affect the catalyst activity. It is also possible for one or more further cation-forming compounds to be additionally added to the catalyst system of the invention in the polymerization process.

The polymerization can be carried out in a known manner in bulk, in suspension, in the gas phase or in a supercritical medium in the customary reactors used for the polymerization of olefins. It can be carried out batchwise or preferably continuously in one or more stages. Solution processes, suspension processes, stirred gas-phase processes or gas-phase fluidized-bed processes are all possible. As solvent or suspension medium, it is possible to use inert hydrocarbons, for example isobutane, or else the monomers themselves.

The polymerization can be carried out at temperatures in the range from −60 to 300° C. and pressures in the range from 0.5 to 3000 bar. Preference is given to temperatures in the range from 50 to 200° C., in particular from 60 to 100° C., and pressures in the range from 5 to 100 bar, in particular from 15 to 70 bar. The mean residence times are usually from 0.5 to 5 hours, preferably from 0.5 to 3 hours. Hydrogen can be used in the polymerization as molar mass regulator and/or to increase the activity. Furthermore, customary additives such as antistats can also be used. In the polymerization, the catalyst system of the invention can be used directly, i.e. it is introduced in pure form into the polymerization system, or it is admixed with inert components such as paraffins, oils or waxes to improve the meterability.

The process of the invention for preparing catalyst systems for olefin polymerization is relatively uncomplicated and makes it possible to prepare catalysts having a good polymerization activity.

The invention is illustrated by the following nonlimiting examples.

### EXAMPLES

General Procedures

The preparation and handling of organometallic compounds and the catalysts were carried out with exclusion or air and moisture under argon (glove box and Schlenk technique). All solvents used were purged with argon and dried over molecular sieves before use.

2,6-Diacetylpyridinebis(4-chloro-2,6-dimethylphenylimine)iron dichloride (complex A) was prepared by the method of Qian et al., Organometallics 2003, 22, 4312-4321.

Complex A:

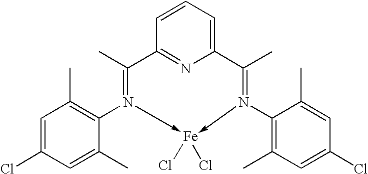

p-Tolylboronic acid (Aldrich) and methylaluminoxane in toluene (Crompton) were commercially available.

The limiting viscosity [η] (also known as intrinsic viscosity) was determined in accordance with ISO 1628-1, 3.3.5.

Polymerization of Ethylene Using Unsupported Catalysts

### Example P1

A solution of 100 ml of toluene and 0.048 ml (0.23 mmol) of methylaluminoxane solution (MAO solution) (4.75 molar solution in toluene) was introduced into a 200 ml steel autoclave by means of a syringe. A solution of 0.26 mg of complex A in 0.048 ml (0.23 mmol) of MAO solution (4.75 molar solution in toluene) was added thereto by means of a syringe. A solution of 1.25 mg of p-tolylboronic acid in 0.5 ml of toluene was subsequently added. The reaction mixture was stirred at 200 rpm in the autoclave for 15 minutes. The autoclave was subsequently pressurized with ethene to a pressure of 20 bar and the temperature was at the same time set to 70° C. The pressure was maintained at 20 bar by addition of ethene. After 10 minutes, the polymerization was stopped by venting the autoclave.

### Example P2

A solution of 100 ml of toluene and 0.048 ml (0.23 mmol) of methylaluminoxane solution (MAO solution) (4.75 molar solution in toluene) was introduced into a 200 ml steel autoclave by means of a syringe. A solution of 0.052 mg of complex A in 0.0096 ml (0.046 mmol) of MAO solution (4.75 molar solution in toluene) was added thereto by means of a syringe. A solution of 0.25 mg of p-tolylboronic acid in 0.1 ml of toluene was subsequently added. The reaction mixture was stirred at 200 rpm in the autoclave for 15 minutes. The autoclave was subsequently pressurized with ethene to a pressure of 20 bar and the temperature was at the same time set to 70° C. The pressure was maintained at 20 bar by addition of ethene. After 15 minutes, the polymerization was stopped by venting the autoclave.

### Comparative Example cP1

A solution of 100 ml of toluene and 0.096 ml (0.46 mmol) of methylaluminoxane solution (MAO solution) (4.75 molar solution in toluene) was introduced into a 200 ml steel autoclave by means of a syringe. A solution of 0.52 mg of complex A in 0.096 ml (0.46 mmol) of MAO solution (4.75 molar solution in toluene) was added thereto by means of a syringe. The reaction mixture was stirred at 200 rpm in the autoclave for 15 minutes. The autoclave was subsequently pressurized with ethene to a pressure of 20 bar and the temperature was at the same time set to 70° C. The pressure was maintained at 20 bar by addition of ethene. After 20 minutes, the polymerization was stopped by venting the autoclave.

Overview of Homogeneous Polymerization:

| Experiment | P1 | P2 | cP1 |
|---|---|---|---|
| Complex 1 [mg] | 0.26 | 0.052 | 0.52 |
| Complex 1 [mmol] | 0.00046 | 0.000095 | 0.00092 |
| p-Tolylboronic acid | 0.0092 | 0.00184 | 0 |
| [mmol] | | | |
| Ratio of | 1:20:1000 | 1:20:3000 | 1:0:1000 |
| Fe:B:Al | | | |
| Yield of PE [g] | 19.9 | 13.9 | 31.8 |
| Activity | 259 | 585 | 104 |
| [kg/mmol * h] | | | |
| Polymerization time | 10 | 15 | 20 |
| [min] | | | |
| Limiting viscosity | 1.1 | 1.6 | 1.5 |
| [η] | | | |
| [dl/g] | | | |

Preparation of the Supported Catalysts

### Example A

A solution of 113 mg (200 μmol) of complex A in 21 ml of MAO (4.75 molar in toluene) was stirred at room temperature for 30 minutes and subsequently diluted with 14.5 ml of toluene. 544 mg (4 mmol) of p-tolylboronic acid were slowly added as a solid, and the resulting solution was stirred for 1 hour.

6.45 g of a support which had been prepared beforehand by reacting 3 kg of silica gel XPO 2107 (Grace) with 1.9 1 of MAO (4.75 molar in toluene) in 48 1 of toluene were placed in a D4 frit filter. The above-described solution was slowly added to the MAO-modified silica gel and the outlet tap was opened slightly so that the solution could impregnate the support. The mixture was then stirred briefly and allowed to stand overnight. The remaining solution was subsequently removed by filtration and the supported catalyst was washed three times with 10 ml each time of heptane and finally dried over nitrogen. 10.2 g of the supported catalyst (C) were isolated.

### Comparative Example B

The catalyst (cC) for the comparative experiment was prepared exactly as described in Example A except that no boronic acid was added.

Polymerization of Ethene Using Supported Catalysts

Polymerization Using the Supported Catalyst C and cC:

General Method:

100 ml of heptane and 1 mmol of triisobutylaluminum (as 2 M solution in heptane) were placed in a 200 ml steel autoclave. The supported catalyst was subsequently introduced into the reactor, the reactor was pressurized with ethene to a pressure of 20 bar and the temperature was at the same time set to 70° C. The pressure was maintained at 20 bar by addition of ethene. After 60 minutes, the polymerization was stopped by venting the reactor.

Supported
catalyst

| | C | cC |
|---|---|---|
| Catalyst [mg] | 15.1 | 12.0 |
| Yield [g] | 46.1 | 21.9 |
| Productivity | 3050 | 1825 |
| [g of PE/g of catalyst] | | |
| Limiting viscosity [η] | 8.5 | 8.4 |
| [dl/g] | | |

1. A process for preparing a catalyst system for olefin polymerization comprising contacting:
A) at least one complex of a transition metal of groups 8 to 10 of the Periodic Table of the elements;
B) at least one aluminoxane; and
C) at least one boron compound of the formula (I):
(R¹)ₐ—B—(OR²)_{b} (I)
where
R¹ is an organic radical having from 1 to 40 carbon atoms;
R² is hydrogen or an organic radical which has from 1 to 40 carbon atoms and is bound via a carbon atom;
a is 1 or 2;
b is 1 or 2;
and a+b=3,
wherein C) is added to component A), B) or to a mixture of A) and B).

2. The process according to claim 1, further comprising adding
D) at least one support
as a further component.

3. The process according to claim 1, wherein the complex A) is an iron compound.

4. The process according to claim 1, wherein the aluminoxane is a methylaluminoxane.

5. The process according to claim 1, wherein the boron compound of the formula (I) is added to a solution comprising A) and B).

6. The process according to claim 1, wherein a molar ratio of the aluminum from component B) to the boron from the component C) is in the range from 1:0.002 to 1:0.05.

7. A catalyst system obtained by a process comprising contacting:
A) at least one complex of a transition metal of groups 8 to 10 of the Periodic Table of the elements;
B) at least one aluminoxane; and
C) at least one boron compound of the formula (I):
(R¹)ₐ—B—(OR²)_{b} (I)
where
R¹ is an organic radical having from 1 to 40 carbon atoms;
R² is hydrogen or an organic radical which has from 1 to 40 carbon atoms and is bound via a carbon atom;
a is 1 or 2;
b is 1 or 2;
and a+b=3,
wherein C) is added to component A), B) or to a mixture of A) and B).

8. (canceled)

9. A process comprising polymerizing olefins with a catalyst system obtained by a process comprising contacting:
A) at least one complex of a transition metal of groups 8 to 10 of the Periodic Table of the elements;
B) at least one aluminoxane; and
C) at least one boron compound of the formula (I):
(R¹)ₐ—B—(OR²)_{b} (I)
where
R¹ is an organic radical having from 1 to 40 carbon atoms;
R² is hydrogen or an organic radical which has from 1 to 40 carbon atoms and is bound via a carbon atom;
a is 1 or 2;
b is 1 or 2;
and a+b=3,
wherein C) is added to component A), B) or to the mixture of A) and B).
